(19) United States
(12) Patent Application Publication
(10) Pub. No.: US 2004/0037568 A1
(43) Pub. Date: Feb. 26, 2004

(54) Optical repeater employed in an optical communication system having a modular dispersion map

(76) Inventor: Stephen G. Evangelides JR., (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/613,917

(22) Filed: Jul. 3, 2003

Related U.S. Application Data
(60) Provisional application No. 60/404,616, filed on Aug. 20, 2002.

(51) Int. Cl. H04B 10/18; H04B 10/16

(52) U.S. Cl. 398/159; 398/177; 398/180

(57) ABSTRACT

An optical transmission system includes a first transmitter unit and a first receiver unit. A first optical transmission path interconnects the first transmitter unit and the first receiver unit. The first optical transmission path is defined by at least three transmission spans. The first optical transmission path has a periodic dispersion map with a first periodic component comprising a fixed portion and an adjustable portion, and a second periodic component greater in length than the first periodic component. The fixed portion of the first periodic component of the periodic dispersion map is provided by the respective transmission spans. A plurality of optical repeaters each optically couple adjacent ones of the transmission spans to one another. A first plurality of adjustable dispersion trimming element are each located in one of the optical repeaters and optically couples one of the transmission spans to an optical amplifier located in the optical repeater. The first adjustable dispersion trimming elements each have an adjustable path average dispersion that provides the adjustable portion of the first periodic component. The adjustable path average dispersion is selected such that the fixed portion of the first periodic component of the periodic dispersion map plus the adjustable component of the dispersion map associated therewith has a desired value.

### STATEMENT OF RELATED APPLICATIONS

This application claims the benefit of priority to U.S. Provisional Patent Application No. 60/404,616, filed Aug. 20, 2002, entitled “Dispersion Map Design.”

This application is also related to copending U.S. patent application Ser. No. ______ [Docket: 9005/1] entitled “Modular Dispersion Map For an Optical Communication System,” filed on even date herewith.

### FIELD OF THE INVENTION

The present invention relates generally to optical transmission systems, and more particularly to a dispersion map for an undersea optical transmission system.

### BACKGROUND OF THE INVENTION

The introduction of multigigabit, multiwavelength optical communication systems operating over long distances (e.g., transoceanic) and high average powers has resulted in the exploration of fiber designs that can minimize signal degradation. In the last decade several new and useful fiber designs have become commercially available. These fibers come with a variety of dispersion, loss, and effective core area values. The goal of all transmission line design is to reduce the deleterious effects of a number of phenomena, including accumulation amplified spontaneous emission (ASE) noise accumulation, group velocity dispersion, and Kerr effect non-linearities.

It turns out there is no one fiber that reduces all these effects at once. For example if the signal travels at the zero dispersion wavelength it will not suffer any temporal distortions. However, at the zero dispersion wavelength the signal and the ASE noise generated by the optical amplifiers and the signal and adjacent signals are well phase matched. Thus they have the opportunity to interact, via four wave mixing and cross phase modulation, over long distances. The result is the transfer of power out of the signal and into unwanted wavelengths and/or the phase modulation of one signal by another. The end result of all this can be a severe degradation in signal fidelity. Conversely if the signal propagates at a wavelength for which the dispersion is large then there is a large phase mismatch (i.e., a group velocity difference) between the signal and noise, which greatly reduces the efficiency of four wave mixing. However, large values of dispersion result in increased inter-symbol interference due to the temporal spreading of the signal

An important advance in the implementation of multi-channel WDM systems has been the use of dispersion management techniques. In view of the above mentioned conflicting demands, the basic principle of dispersion management is to keep local dispersion non-zero but make the overall system dispersion substantially zero. This can be accomplished by using a dispersion map in which the zero dispersion wavelengths of the constituent fibers are chosen so that they are appropriately far from the system's operating wavelengths. Constituent fibers with different zero dispersion wavelengths are then arranged in some periodic fashion so that the path average dispersion for the whole transmission line is appropriately small. For example, the transmission line may be divided into two or more sections approximately equal length. In one section, the optical fiber has a zero dispersion wavelength less than the operating wavelengths. The following section has optical fiber with a zero dispersion wavelength greater than the operating wavelengths. The overall transmission line is thus constructed in a periodic manner from a concatenation of fiber sections having different zero dispersion wavelengths. By constructing the transmission line out of alternating lengths of positive and negative dispersion fiber, the path average dispersion can be adjusted so that it causes minimal temporal distortion. Moreover, by selecting the local dispersions of the constituent fibers to be large in magnitude, nonlinear interactions can be suppressed. The path-average dispersion of a fiber span of length L may be mathematically denoted as:

$${D}_{average} = \frac{1}{L} {\int }_{z = 0}^{z = L} D ( z ) ⅆ z$$

For applications involving the transmission of non-return-to-zero (NRZ) data, the desired D_{average} is zero, while, for soliton data transmission, the desired D_{average} is in the range of about 0.05 to 0.5 picoseconds per nanometer-kilometer.

Undersea optical communication systems have been traditionally custom-designed on a system-by-system basis. Fundamental design parameters such as amplifier spacing, amplifier gains and bandwidths, dispersion maps, data rate, wavelength count and constituent fiber are often significantly different from system to system. For example, amplifier span length (i.e., the length of fiber between consecutive amplifiers) varies from about 33 km to 80 km. Hence the amplifier gains vary from about 8 dB to 16 dB, requiring amplifiers with very different designs. Dispersion maps have also varied in length and in composition of the constituent fiber.

One problem that arises when the dispersion map of undersea communication systems differs from system to system is that a great variety of optical fiber must be available that have the proper length and dispersion for the segments of each different dispersion map. The need for such a variety of different fibers increases their manufacturing costs and therefore system costs. Moreover, the cost to maintain a supply of replacement fibers in inventory is increased when so many different fibers must be maintained.

### SUMMARY OF THE INVENTION

In accordance with the present invention, an optical transmission system includes a first transmitter unit and a first receiver unit. A first optical transmission path interconnects the first transmitter unit and the first receiver unit. The first optical transmission path is defined by at least three transmission spans. The first optical transmission path has a periodic dispersion map with a first periodic component comprising a fixed portion and an adjustable portion, and a second periodic component greater in length than the first periodic component. The fixed portion of the first periodic component of the periodic dispersion map is provided by the respective transmission spans. A plurality of optical repeaters each optically couple adjacent ones of the transmission spans to one another. A first plurality of adjustable dispersion trimming element are each located in one of the optical repeaters and optically couples one of the transmission spans to an optical amplifier located in the optical repeater. The first adjustable dispersion trimming elements each have an adjustable path average dispersion that provides the adjustable portion of the first periodic component. The adjustable path average dispersion is selected such that the fixed portion of the first periodic component of the periodic dispersion map plus the adjustable component of the dispersion map associated therewith has a desired value.

In accordance with one aspect of the invention, at least a first and second of the at least three transmission spans define the second periodic component of the dispersion map.

In accordance with another aspect of the invention, at least four transmission spans are provided. The third and fourth of the transmission spans each have a total path average dispersion different from a path average dispersion of the first and second transmission spans.

In accordance with another aspect of the invention, the first and second transmission spans plus the dispersion trimming elements respectively constitute the second periodic component of the dispersion map.

In accordance with another aspect of the invention, a second transmitter unit is associated with the first receiver unit and a second receiver unit is associated with the first transmitter unit. A second optical transmission path interconnects the second transmitter unit and the second receiver unit. The second optical transmission path, which is defined by at least three second transmission spans, has a periodic dispersion map that is equal to the periodic dispersion map of the first optical transmission path as experienced by an optical signal traveling from the second transmitter unit to the second receiver unit. The plurality of optical repeaters each include a second adjustable dispersion trimming element each optically coupling one of the second transmission spans to an optical amplifier located in each repeater.

In accordance with another aspect of the invention, each of the optical repeaters in the plurality of optical repeaters is substantially identical to and interchangeable with one another.

In accordance with another aspect of the invention, the adjustable dispersion trimming elements each have an adjustable path average dispersion that provides the adjustable portion of the first periodic component. The adjustable path average dispersion is selected such that the fixed portion of the first periodic component of the periodic dispersion map plus the adjustable component of the dispersion map associated therewith has a desired value.

In accordance with another aspect of the invention, each of the adjustable dispersion trimming elements is coupled to an input of one of the optical amplifiers.

In accordance with another aspect of the invention, each of the adjustable dispersion trimming elements is coupled to an output of one of the optical amplifiers.

In accordance with another aspect of the invention, the fixed portion of the periodic dispersion map is approximately equal to zero.

In accordance with another aspect of the invention, the adjustable dispersion trimming elements comprise spooled optical fiber.

In accordance with another aspect of the invention, the adjustable dispersion trimming elements comprise a Bragg grating.

In accordance with another aspect of the invention, at least one of the transmission spans comprises a cabled optical fiber having a single value of dispersion.

In accordance with another aspect of the invention, at least one of the transmission spans comprises a plurality of cabled optical fibers each having a different value of dispersion. In accordance with another aspect of the invention, the spooled optical fiber has a dispersion value substantially greater than the single dispersion value of the cabled optical fiber.

In accordance with another aspect of the invention, a method is provided for establishing a dispersion map for an optical transmission system having an optical transmission path that includes a plurality of optical amplifiers interconnected by respective transmission spans. The method begins by selecting a periodic dispersion map with a first periodic component comprising a fixed portion and an adjustable portion and a second periodic component greater in length than the first periodic component. The fixed portion of the first periodic component of the periodic dispersion map is provided by the respective transmission spans. For each given period of the first periodic component, a path average dispersion is adjusted to achieve the desired path average dispersion by trimming the second adjustable component associated with the given period.

In accordance with another aspect of the invention, a method is provided for assembling an optical transmission system. The method begins by providing a plurality of optical repeaters each having an input and output. Each of the repeaters includes an optical amplifier and an adjustable dispersion trimming element. A plurality of spans of cabled optical fiber is also provided. The input and output of each of the repeaters are optically coupled to an end of one of the spans of cabled optical fiber to form a transmission path having a concatenation of optical repeaters such that each of the spans of cabled optical fiber is associated with one of the adjustable dispersion trimming elements. A path average dispersion of the adjustable dispersion trimming elements is adjusted to achieve a desired total path average dispersion for the cabled optical fiber span and the adjustable trimming element associated therewith.

### BRIEF DESCRIPTION OF THE DRAWINGS

FIG. 1 shows a simplified block diagram of an exemplary wavelength division multiplexed transmission system in accordance with the present invention.

FIG. 2 shows a single transmission span of the transmission system depicted in FIG. 1 to which optical repeaters are connected.

FIG. 3 shows an exemplary transmission span comprising a cabled optical fiber having two components with length L₁ and L₂ and dispersions D₁ and D₂, respectively.

FIG. 4 shows a schematic diagram of a repeater constructed in accordance with the present invention.

FIGS. 5 and 6 each show one half of a bidirectional transmission system having a dispersion map in which a second periodicity is introduced

### DETAILED DESCRIPTION

The present invention provides a modular, single span, dispersion map with an adjustable path average dispersion. A modular dispersion map eliminates many design problems associated with multispan dispersion maps, most significantly matching the period of the dispersion map to some multiple of the amplifier span length. Such a modular adjustable dispersion map can be made to accommodate most modulation formats quite easily.

In particular, the present inventors have recognized that significant advantages and cost savings can be achieved by using a dispersion map that comprises two components and has a period that is equal to the amplifier span length. The first is a fixed combination of two fibers of chosen dispersions and lengths. The second component is an adjustable portion of the dispersion map that is used to trim the fixed periodic portion as needed on a system-by-system or span-by-span basis. The optical fiber of the transmission path comprises the fixed, periodic component. By deliberate and judicious design choices, the fixed periodic component is the same from system to system, thereby reducing the number of different optical fibers that are required. The fixed period of the dispersion map is preferably selected to be as small as is practical to enhance the flexibility of the design. For example, in one particular embodiment of the invention, the fixed periodic component has a length equal to the span of optical fiber that connects adjacent amplifiers.

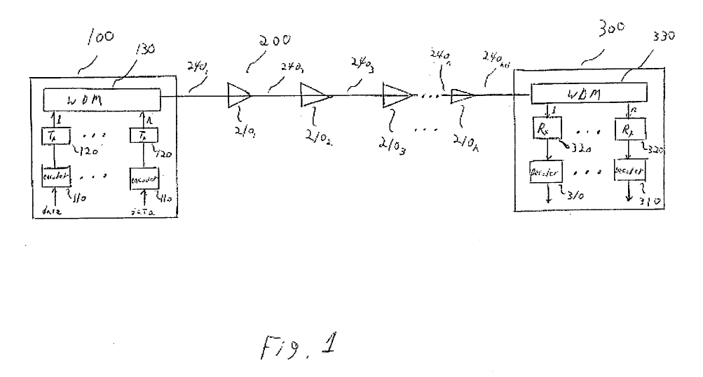

FIG. 1 shows a simplified block diagram of an exemplary wavelength division multiplexed (WDM) transmission system in accordance with the present invention. The transmission system serves to transmit a plurality of optical channels over a single path from a transmitting terminal to a remotely located receiving terminal. While FIG. 1 depicts a unidirectional transmission system, it should be noted that if a bi-directional communication system is to be employed, two distinct transmission paths are used to carry the bi-directional communication. The optical transmission system may be an undersea transmission system in which the terminals are located on shore and one or more repeaters may be located underwater

Transmitter terminal 100 is connected to an optical transmission medium 200, which is connected, in turn, to receiver terminal 300. Transmitter terminal 100 includes a series of encoders 110 and digital transmitters 120 connected to a wavelength division multiplexer 130. For each WDM channel, an encoder 110 is connected to a digital transmitter 120, which, in turn, is connected to the wavelength division multiplexer 130. In other words, wavelength division multiplexer 130 receives signals associated with multiple WDM channels, each of which has an associated digital transmitter 120 and encoder 110. Transmitter terminal 100 also includes a chromatic dispersion compensator 140 that precompensates for dispersion arising in transmission medium 200.

Digital transmitter 120 can be any type of system component that converts electrical signals to optical signals. For example, digital transmitter 120 can include an optical source such as a semiconductor laser or a light-emitting diode, which can be modulated directly by, for example, varying the injection current. WDM multiplexer 130 can be any type of device that combines signals from multiple WDM channels. For example, WDM multiplexer 130 can be a star coupler, a fiber Fabry-Perot filter, an in-line Bragg grating, a diffraction grating, cascaded filters and a wavelength grating router, among others.

Receiver terminal 300 includes a series of decoders 310, digital receivers 320 and a wavelength division demultiplexer 330. WDM demultiplexer 330 can be any type of device that separates signals from multiple WDM channels. For example, WDM demultiplexer 330 can be a star coupler, a fiber Fabry-Perot filter, an in-line Bragg grating, a diffraction grating, cascaded filters and a wavelength grating router, among others. Receiver terminal 300 also includes a chromatic dispersion compensator 340 that provides post-compensation for dispersion arising in transmission medium 200.

Optical transmission medium 200 includes rare-earth doped optical amplifiers 210₁-210ₙ interconnected by transmission spans 240₁-240ₙ₊₁ of optical fiber. If a bi-directional communication system is to be employed, rare-earth doped optical amplifiers are provided in each transmission path. Moreover, in a bi-directional system each of the terminals 100 and 300 include a transmitter and a receiver. In a bi-directional undersea communication system a pair of rare-earth doped optical amplifiers supporting opposite-traveling signals is often housed in a single unit known as a repeater. While only four rare-earth optical amplifiers are depicted in FIG. 1 for clarity of discussion, it should be understood by those skilled in the art that the present invention finds application in transmission paths of all lengths having many additional (or fewer) sets of such amplifiers.

Each of the transmission spans 240₁-240ₙ₊₁ comprise optical fiber enclosed in a cable designed to withstand the undersea environment. As previously mentioned, in one embodiment of the invention each transmission span, and therefore each span of cabled optical fiber, constitutes the fixed, periodic component of the dispersion map. Each transmission span may comprise one or more types of optical fiber having different zero dispersion wavelengths so that the path average dispersion of each span, and hence the path average dispersion of the fixed component of the dispersions map, is either zero or some other appropriate value determined in part by the modulation format that is employed.

In accordance with the present invention, the adjustable portion of the dispersion map is provided by an adjustable dispersion trimming element having a given dispersion value so that the path average dispersion of the transmission span plus the adjustable dispersion trimming element is tailored to some precise value that is appropriate for the particular modulation format and transmission distance that is employed in any given system.

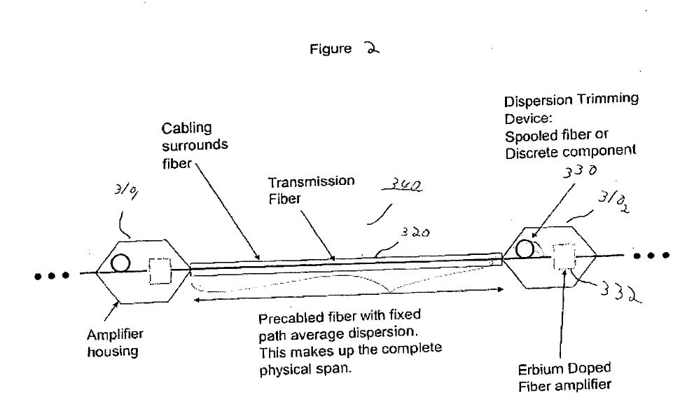

The adjustable dispersion trimming element, which may be spooled fiber or a discrete device such as a Bragg grating, for example, may be conveniently located in the housing of the repeaters. For example, FIG. 2 shows a single transmission span 340 interconnected by adjacent repeaters 310, and 3102. Transmission span 340 comprises cabled fiber 320. The adjustable dispersion trimming element 330 is shown as spooled fiber that is located in repeater 3102 and extends from the termination of the cabled fiber 320 to the input of the optical amplifier 3322.

One advantage of the present invention is that it achieves the cost savings and simplicity in design that arises from the use of a common transmission span that is the same for each and every span within a given system as well as among different systems, combined with the flexibility to trim the dispersion map on a system by system and/or a span by span basis. That is, when the system is initially installed, all that is needed are multiple units of a single cabled fiber having a prescribed length and path average dispersion. Any adjustments to the dispersion map can be readily performed within the housings of the repeaters, either by trimming spooled fiber to the appropriate length or by appropriate adjustment of a discrete device.

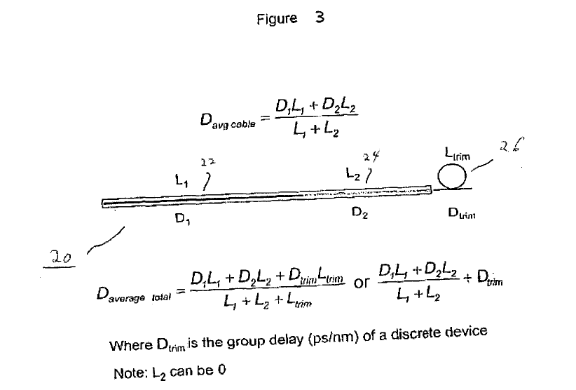

FIG. 3 shows an exemplary transmission span comprising a cabled fiber having two components 22 and 24 with lengths L₁ and L₂ and dispersions D₁ and D₂, respectively. A dispersion trimming element 26 has a length Lₜᵣᵢₘ and a dispersion Dₜᵣᵢₘ. The path average dispersion of the transmission span 20 plus the dispersion trimming element 26, D_{average total}, is

D_{average total}=(D₁L₁+D₂L₂+DₜᵣᵢₘLₜᵣᵢₘ)/(L₁+L₂+Lₜᵣᵢₘ)

The path average dispersion of the transmission span should be selected so that the requisite dispersion trimming element does not significantly degrade the overall performance of the system. In particular, the optical loss, PMD and PDL associated with the dispersion trimming element should be minimized. Accordingly, the path average dispersion of the transmission span should be selected so that the dispersion trimming element only needs to make a small contribution to D_{average total}. Hence the path average dispersion of the transmission span is preferably close to zero. This is not a significant constraint since most long haul systems operate best at small absolute values of dispersion, typically between about 0.1 and 1.0 ps/nm-km in magnitude.

As a numerical example, assume the path average of the fixed portion of the dispersion map is D₁=+0.3 ps/nm-km with a period of 50 km, and Dₜᵣᵢₘ=−100 ps/nm-km. The addition of 150 m of dispersion trimming fiber can reduce the total path average dispersion D_{average} total to zero. If an additional 150 m of dispersion trimming fiber is added, D_{average total} will be changed to −0.3 ps/nm-km. This additional fiber only adds at most an extra fiber loss of about 0.1 dB and perhaps another 0.15 dB for splice losses. The total loss can be directly built into the amplifier design budget.

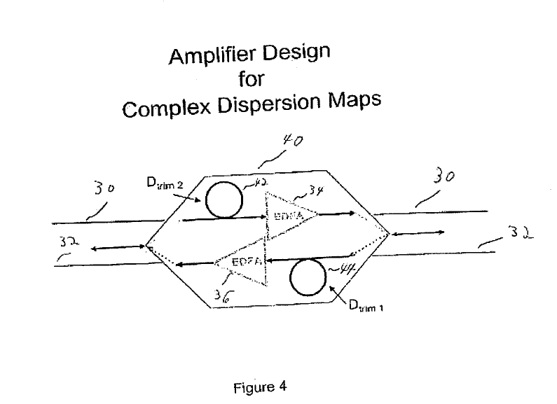

As the example illustrates, the dispersion trimming fiber is preferably a high dispersion fiber so that the total path average dispersion can be appropriately adjusted with small a length of fiber as possible. Since high dispersion fiber has a relatively small core area (e.g., about 25 μm² for the aforementioned −100 ps/nm-km fiber), the dispersion trimming fiber is preferably added at the end of transmission span, where the signal intensity is lowest, rather than at the beginning of the span where the signal intensity is highest. In this way nonlinear penalties are reduced because the power density in the dispersion trimming fiber will be less when it is positioned at the end of the transmission span. For example, in FIG. 2, dispersion trimming fiber 26 is located at the end of transmission span 20. Similarly, FIG. 4 shows a schematic diagram of a repeater 40 for a bidirectional transmission system having unidirectional fibers 30 and 32. The repeater includes optical amplifiers 34 and 36 for providing amplification to signals traveling along fibers 30 and 32, respectively. As shown, the dispersion trimming fibers 42 and 44 are each located at the respective inputs to the optical amplifiers 34 and 36, and thus at the end of their respective transmission spans. Of course, in other embodiments of the invention the dispersion trimming fibers (or other adjustable dispersion trimming element) may be located at the output of the optical amplifier preceding a given transmission span.

In some embodiments of the invention a second periodicity can be introduced. That is, by appropriate adjustment of the dispersion value of the dispersion trimming element individual spans can be given different path average dispersion values. These individual spans, trimmed to different path average dispersions can be concatenated to make dispersion maps having periods longer than one transmission span. We will call this multiple span dispersion map a super map in that it is a long period map composed of individual spans which have associated with them single span dispersion maps. For example the length of the transmission line can be comprised of two sets of spans. Half of the spans are trimmed to have a path average value D₁ and the other set of spans are trimmed to have a path average value D₂. Then a group of spans with a path average dispersion D₁ can be concatenated followed by a group of spans having a path average average dispersion D₂. This pattern can be repeated. In particular, any dispersion super map can be achieved that consists of two dispersion values and in which there is odd symmetry (in the plot of dispersion (ps/nm-km) vs. distance) about the middle of the whole link. For example, for a transmission path of total length L that is made up of M individual transmission spans, the first M/2 spans can have a total path average dispersion less than zero, while the next M/2 spans have a total path average dispersion greater than zero. The path average dispersion of the entire transmission path of length L can have any appropriate value determined by the total path average dispersions of the first and second M/2 spans.

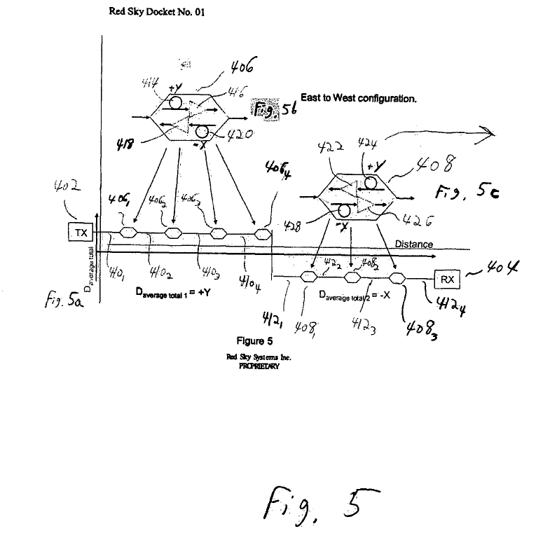

FIG. 5a shows the configuration of one half of a bidirectional WDM transmission system having a dispersion map with a second periodicity as described above. In FIG. 5 the optical signals are depicted as traveling from west to east. Transmitter and receiver terminals 402 and 404 are interconnected by an optical transmission medium that comprises transmission spans 410₁-410₄ and 412₁-412₄. Transmission spans 410₁-410₄ are concatenated by optical repeaters 406₁-406₄ and transmission spans 412₁-412₄ are concatenated by optical repeaters 408₁-408₃. As the figure indicates, the total path average dispersion of transmission spans 410₁-410₄ plus their respective adjustable dispersion trimming elements located in repeaters 406₁-406₄ is selected to be +Y, whereas the total path average dispersion of transmission spans 412₁-412₄ plus their respective adjustable dispersion trimming elements located in repeaters 408₁-408₃ is selected to by −X.

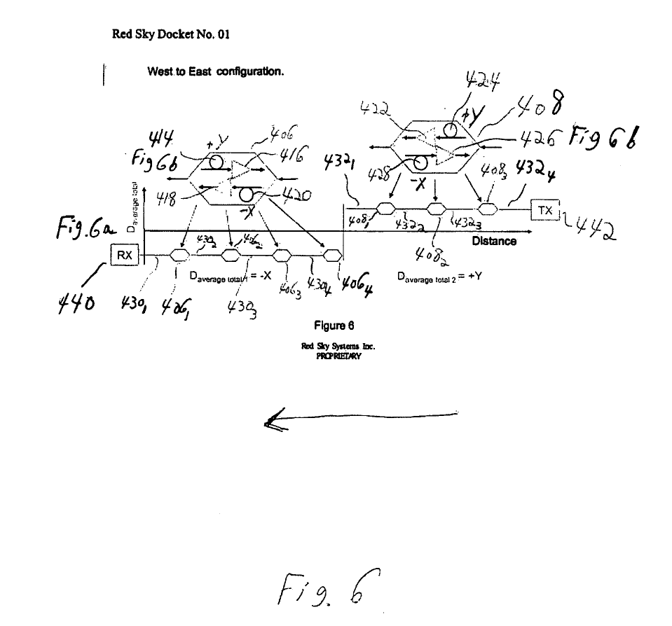

FIG. 5b shows a detail of the repeaters 406₁-406₄, which are identical to one another. Likewise, FIG. 5c shows a detail of the repeaters 408₁-408₄, which are also identical to one another. Repeaters 406 and 408 support not only the west to east transmission medium in FIG. 5, but also the corresponding east to west transmission medium shown in FIG. 6, which is described below. Dispersion trimming element 414 and optical amplifier 416 in repeaters 406 support the west to east transmission medium of FIG. 5 and dispersion trimming element 420 and optical amplifier 418 support the east to west transmission medium of FIG. 6. Similarly, dispersion trimming elements 428 and optical amplifiers 426 in repeaters 408 support the west to east transmission medium of FIG. 5 and dispersion trimming elements 424 and optical amplifiers 422 support the east to west transmission medium of FIG. 6. Dispersion trimming elements 414 have a dispersion value D414 and dispersion trimming elements 428 have a dispersion value D428, which are chosen so that when they are added to the dispersion of their associated transmission spans, the total path average dispersions +Y and −X, respectively, are achieved.

FIG. 6 shows the configuration of the complementary half of the bidirectional WDM transmission system of FIG. 5 in which the optical signals are depicted as traveling east to west. Transmitter and receiver terminals 442 and 440 are interconnected by an optical transmission medium that comprises transmission spans 4301-4304 and 4321-4324. Transmission spans 430₁-430₄ are concatenated by optical repeaters 406₁-406₄ (which are also shown in FIG. 5) and transmission spans 432₁-432₄ are concatenated by optical repeaters 408₁-408₃ (which are also shown in FIG. 5).

In a bi-directional transmission system the dispersion map going in one direction will be the complement of the dispersion map going in the opposite direction. That is, the dispersion map experienced by an optical signal traveling from transmitter 402 to receiver 404 in FIG. 5 is generally the same as the dispersion map experienced by an optical signal traveling from transmitter 442 to receiver 440. Accordingly, given the dispersion map of the transmission medium depicted in FIG. 5, the dispersion map of the transmission medium depicted in FIG. 6 will be as follows: The total path average dispersion of transmission spans 430₁-430₄ plus their respective adjustable dispersion trimming elements located in repeaters 406 is selected to be −X, whereas the total path average dispersion of transmission spans 432₁-432₄ plus their respective adjustable dispersion trimming elements in repeaters 408 is selected to by +Y. It should be emphasized that the path average dispersion of cabled transmission spans 430₁-430₄ and spans 432₁-432₄ are all the same. Only path average dispersion of the adjustable dispersion trimming elements are different.

FIG. 6b shows a detail of the repeaters 406₁-406₄ and FIG. 6c shows a detail of the repeaters 408₁-408₄. That is, FIGS. 6b and 6c are the same as FIGS. 5b and 5c, respectively. When supporting east to west transmission as in FIG. 6, dispersion trimming elements 420 and optical amplifiers 418 are employed in repeaters and dispersion trimming elements 424 and optical amplifiers 422 are employed in repeaters 408. Dispersion trimming elements 420 have a dispersion value D420 and dispersion trimming elements 424 have a dispersion value D424, which are chosen so that when they are added to the dispersion of their associated transmission spans, the total path average dispersions are −X and +Y, respectively. Clearly, because of the symmetry of the dispersion maps for two transmission directions, the dispersion value D414 of dispersion trimming elements 414 is the same as the dispersion value D424 of the dispersion trimming elements 424. Likewise, the dispersion value D420 of dispersion trimming elements 420 is the same as the dispersion value D428 of the dispersion trimming elements 428.

An important result of the above analysis is that repeaters 406 and 408 are identical to one another. The only difference between them is that when they are inserted into the transmission paths, their input and output ports are reversed with respect to one another. Thus, a relatively complex dispersion map can be achieved using not only identical spans of cabled optical fiber, but also using identical repeaters. The two dispersion trimming elements in each repeater can therefore be convenientally pre-adjusted prior to system deployment since their values are the same for every repeater, thereby allowing the repeaters to be stored in inventory until they are needed

1. An optical transmission system, comprising:
a first transmitter unit;
a first receiver unit;
a first optical transmission path interconnecting the first transmitter unit and the first receiver unit, said first optical transmission path being defined by at least three transmission spans, said first optical transmission path having a periodic dispersion map with a first periodic component comprising a fixed portion and an adjustable portion and a second periodic component greater in length than the first periodic component, said fixed portion of the first periodic component of the periodic dispersion map being provided by the respective transmission spans;
a plurality of optical repeaters each optically coupling adjacent ones of the transmission spans to one another;
a first plurality of adjustable dispersion trimming element each located in one of said optical repeaters and optically coupling one of said transmission spans to an optical amplifier located in said one optical repeater, said first adjustable dispersion trimming elements each having an adjustable path average dispersion that provides said adjustable portion of the first periodic component, said adjustable path average dispersion being selected such that the fixed portion of the first periodic component of the periodic dispersion map plus the adjustable component of the dispersion map associated therewith has a desired value.

2. The optical transmission system of claim 1 wherein at least first and second of the at least three transmission spans define the second periodic component of the dispersion map.

3. The optical transmission system of claim 1 wherein said at least three transmission spans comprises at least four transmission spans, wherein the third and fourth of the transmission spans each have a total path average dispersion different from a path average dispersion of the first and second transmission spans.

4. The optical transmission system of claim 1 wherein the first and second transmission spans plus the dispersion trimming elements respectively constitute the second periodic component of the dispersion map.

5. The optical transmission system of claim 1 further comprising:
a second transmitter unit associated with the first receiver unit;
a second receiver unit associated with the first transmitter unit;
a second optical transmission path interconnecting the second transmitter unit and the second receiver unit, said second optical transmission path being defined by at least three second transmission spans, said second optical transmission path having a periodic dispersion map that is equal to said periodic dispersion map of the first optical transmission path as experienced by an optical signal traveling from the second transmitter unit to the second receiver unit;
wherein said plurality of optical repeaters each include a second adjustable dispersion trimming element each optically coupling one of said second transmission spans to an optical amplifier located in each repeater.

6. The optical transmission system of claim 1 wherein each of the optical repeaters in the plurality of optical repeaters is substantially identical to and interchangeable with one another.

7. The optical transmission system of claim 5 wherein each of the optical repeaters in the plurality of optical repeaters is substantially identical to and interchangeable with one another.

8. The optical transmission system of claim 1 wherein said adjustable dispersion trimming elements each having an adjustable path average dispersion that provides said adjustable portion of the first periodic component, said adjustable path average dispersion being selected such that the fixed portion of the first periodic component of the periodic dispersion map plus the adjustable component of the dispersion map associated therewith has a desired value.

9. The optical transmission system of claim 1 wherein each of the adjustable dispersion trimming elements is coupled to an input of one of the optical amplifiers.

10. The optical transmission system of claim 1 wherein each of the adjustable dispersion trimming elements is coupled to an output of one of the optical amplifiers.

11. The optical transmission system of claim 1 wherein said fixed portion of the periodic dispersion map is approximately equal to zero.

12. The optical transmission system of claim 1 wherein said optical amplifier is a rare-earth doped optical amplifier.

13. The optical transmission system of claim 1 wherein said adjustable dispersion trimming elements comprise spooled optical fiber.

14. The optical transmission system of claim 1 wherein said adjustable dispersion trimming elements comprise a Bragg grating.

15. The optical transmission system of claim 1 wherein at least one of said transmission spans comprises a cabled optical fiber having a single value of dispersion.

16. The optical transmission system of claim 1 wherein at least one of said transmission spans comprises a plurality of cabled optical fibers each having a different value of dispersion.

17. The optical transmission system of claim 8 wherein at least one of said transmission spans comprises a cabled optical fiber having a single value of dispersion.

18. The optical transmission system of claim 12 wherein said spooled optical fiber has a dispersion value substantially greater than said single dispersion value of the cabled optical fiber.

19. A method of establishing a dispersion map for an optical transmission system, having an optical transmission path that includes a plurality of optical amplifiers interconnected by respective transmission spans, said method comprising the steps of:
selecting a periodic dispersion map with a first periodic component comprising a fixed portion and an adjustable portion and a second periodic component greater in length than the first periodic component, said fixed portion of the first periodic component of the periodic dispersion map being provided by the respective transmission spans; and
for each given period of the first periodic component, adjusting a path average dispersion to achieve said desired path average dispersion by trimming the second adjustable component associated with the given period.

20. The method of claim 19 wherein said respective transmission spans comprises at least three transmission spans, wherein a first and second of the at least three transmission spans define the second periodic component of the dispersion map.

21. The method of claim 19 wherein said respective transmission spans comprises at least four transmission spans, a third and fourth of the transmission spans each having a total path average dispersion different from a path average dispersion of a first and second of the transmission spans.

22. The method of claim 19 wherein said optical transmission path is a bidirectional transmission path and further comprising a plurality of optical repeaters in which the optical amplifiers are respectively housed, wherein each of the optical repeaters in the plurality of optical repeaters is substantially identical to and interchangeable with one another.

23. The method of claim 19 wherein the adjusting step is performed by at least one adjustable dispersion trimming element associated with one of the optical amplifiers.

24. The method of claim 23 wherein said at least one adjustable dispersion trimming element comprises a plurality of adjustable dispersion trimming elements respectively associated with the plurality of optical amplifiers and being optically coupled to a respective one of the transmission spans.

25. The method of claim 23 wherein said at least one adjustable dispersion trimming element is located at an input to the optical amplifier.

26. The method of claim 23 wherein said at least one adjustable dispersion trimming element is located at an output to the optical amplifier.

27. The method of claim 19 wherein the adjusting step is performed by at least one adjustable dispersion trimming element associated with one of the optical repeaters.

28. The method of claim 27 wherein said at least one adjustable dispersion trimming element is located at an input to the optical repeater.

29. The method of claim 27 wherein said at least one adjustable dispersion trimming element is located at an output to the optical repeater.

30. The method of claim 19 wherein said first fixed portion of the periodic dispersion map is approximately equal to zero.

31. The method of claim 19 wherein said optical amplifier is a rare-earth doped optical amplifier.

32. The method of claim 27 wherein said adjustable dispersion trimming element comprises spooled optical fiber.

33. The method of claim 27 wherein said adjustable dispersion trimming element comprises a Bragg grating.

34. The method of claim 19 wherein at least one of said transmission spans comprises a cabled optical fiber having a single value of dispersion.

35. The method of claim 19 wherein at least one of said transmission spans comprises a plurality of cabled optical fibers each having a different value of dispersion.

36. The method of claim 32 wherein at least one of said transmission spans comprises a cabled optical fiber having a single value of dispersion.

37. The method of claim 36 wherein said spooled optical fiber has a dispersion value substantially greater than said single dispersion value of the cabled optical fiber.

38. A method of assembling an optical transmission system, said method comprising the steps of:
providing a plurality of optical repeaters each having an input and output, each of said repeaters including an optical amplifier and an adjustable dispersion trimming element;
providing a plurality of spans of cabled optical fiber;
optically coupling the input and output of each of the repeaters to an end of one of the spans of cabled optical fiber to form a transmission path having a concatenation of optical repeaters such that each of the spans of cabled optical fiber is associated with one of the adjustable dispersion trimming elements; and
adjusting a path average dispersion of the adjustable dispersion trimming elements to achieve a desired total path average dispersion for the cabled optical fiber span and the adjustable trimming element associated therewith.

39. The method of claim 38 wherein each of said optical repeaters are substantially identical to and interchangeable with one another.

40. The method of claim 39 wherein at least two of cabled fiber spans have dispersion values that differ from one another.

41. The method of claim 38 wherein said transmission path has a dispersion map with a period equal to one of the spans of cabled optical fiber plus the adjustable dispersion trimming element associated therewith.

42. The method of claim 38 wherein said transmission path has a dispersion map with a period greater than one of the spans of cabled optical fiber plus the adjustable dispersion trimming element associated therewith.

43. The method of claim 39 wherein said transmission path has a dispersion map with a period equal to one of the spans of cabled optical fiber plus the adjustable dispersion trimming element associated therewith.

44. The method of claim 39 wherein said transmission path has a dispersion map with a period greater than one of the spans of cabled optical fiber plus the adjustable dispersion trimming element associated therewith.

45. The method of claim 38 wherein said adjustable dispersion trimming elements are respectively located at the inputs to the optical repeaters.

46. The method of claim 38 wherein said adjustable dispersion trimming elements are respectively at the outputs to the optical repeaters.

47. The method of claim 38 wherein said optical amplifiers are rare-earth doped optical amplifiers.

48. The method of claim 38 wherein said adjustable dispersion trimming elements comprise spooled optical fibers.

49. The method of claim 38 wherein said adjustable dispersion trimming elements comprise Bragg gratings.

50. The method of claim 38 wherein at least one of said spans of cabled optical fiber comprises a cabled optical fiber having a single value of dispersion.

51. The method of claim 38 wherein at least one of said spans of cabled optical fiber comprises a plurality of cabled optical fibers each having a different value of dispersion.

52. The method of claim 48 wherein at least one of said spans of cabled optical fiber comprises a cabled optical fiber having a single value of dispersion.

53. The method of claim 52 wherein said spooled optical fiber has a dispersion value substantially greater than said single dispersion value of the cabled optical fiber.
